(19) United States
(12) Patent Application Publication
(10) Pub. No.: US 2007/0098383 A1
(43) Pub. Date: May 3, 2007

(54) Motion blur reduction and compensation

(76) Inventors: Donald J. Stavely, Windsor, CO (US); Andrew C. Goris, Loveland, CO (US); David K. Campbell, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,119

(22) Filed: Oct. 28, 2005

(51) Int. Cl. G03B 17/00

(52) U.S. Cl. 396/55

(57) ABSTRACT

A method and apparatus are disclosed for reducing motion blur in photographs. In one example embodiment, a camera includes logic configured to monitor motion of the camera. The logic selects, based on the camera motion, a starting time, and ending time, or both for a photographic exposure such that extreme motion blur is avoided. The logic applies digital image processing to the resulting photograph to compensate for any residual motion blur that occurs.

### CROSS REFERENCE TO RELATED APPLICATIONS

This application is related to the following application, which is filed on the same date as this application, and which is assigned to the assignee of this application:

Exposure boundary selection for motion blur compensation (U.S. application Ser. No. ______ not yet assigned);

### FIELD OF THE INVENTION

The present invention relates generally to photography.

### BACKGROUND

Image blur caused by camera shake is a common problem in photography. The problem is especially acute when a lens of relatively long focal length is used, because the effects of camera motion are magnified in proportion to the lens focal length. Many cameras, including models designed for casual “point and shoot” photographers, are available with zoom lenses that provide quite long focal lengths. Especially at the longer focal length settings, camera shake may become a limiting factor in a photographer's ability to take an unblurred photograph, unless corrective measures are taken.

Some simple approaches to reducing blur resulting from camera shake include placing the camera on a tripod, and using a “fast” lens that enables relatively short exposure times. However, a tripod may not be readily available or convenient in a particular photographic situation. A “fast” lens is one with a relatively large aperture. However large-aperture lenses are often bulky and expensive and not always available. In addition, the photographer may wish to use a smaller lens aperture to achieve other photographic effects such as large depth of field.

Various devices and techniques have been proposed to help address the problem of image blur due to camera shake. Some cameras or lenses are equipped with image stabilization mechanisms that sense the motion of the camera and move one or more optical elements in such a way as to compensate for the camera shake. Such motion-compensation systems often add complexity and cost to a camera.

### BRIEF DESCRIPTION OF THE DRAWINGS

FIG. 1 shows a simplified block diagram of a digital camera in accordance with an example embodiment of the invention.

FIG. 2 shows a perspective view of the digital camera of FIG. 1, and illustrates a coordinate system convenient for describing camera motions.

FIG. 3 shows a schematic top view of the camera of FIG. 1, and illustrates how camera rotation can cause image blur.

FIG. 4 shows portion of a motion sensing element in accordance with an example embodiment of the invention.

FIG. 5 illustrates a scene, a portion of which is to be photographed.

FIG. 6 illustrates a “blur vector”.

FIG. 7 depicts scene the scene of FIG. 5 as it would appear blurred by the camera motion represented by blur vector of FIG. 6.

FIG. 8 depicts a photograph taken of a portion of the scene of FIG. 5.

FIG. 9 shows the two-dimensional Fourier transform of the photograph of FIG. 8.

FIG. 10 shows the two-dimensional Fourier transform of the image of FIG. 6.

FIG. 11 shows the Fourier transform that results from dividing the Fourier transform of FIG. 9 by Fourier transform of FIG. 10.

FIG. 12 shows a recovered photograph, which is the result of computing the two-dimensional inverse of the Fourier transform of FIG. 11.

FIG. 13 shows an example motion trajectory.

FIG. 14 shows a flowchart of a method in accordance with an example embodiment of the invention.

### DETAILED DESCRIPTION

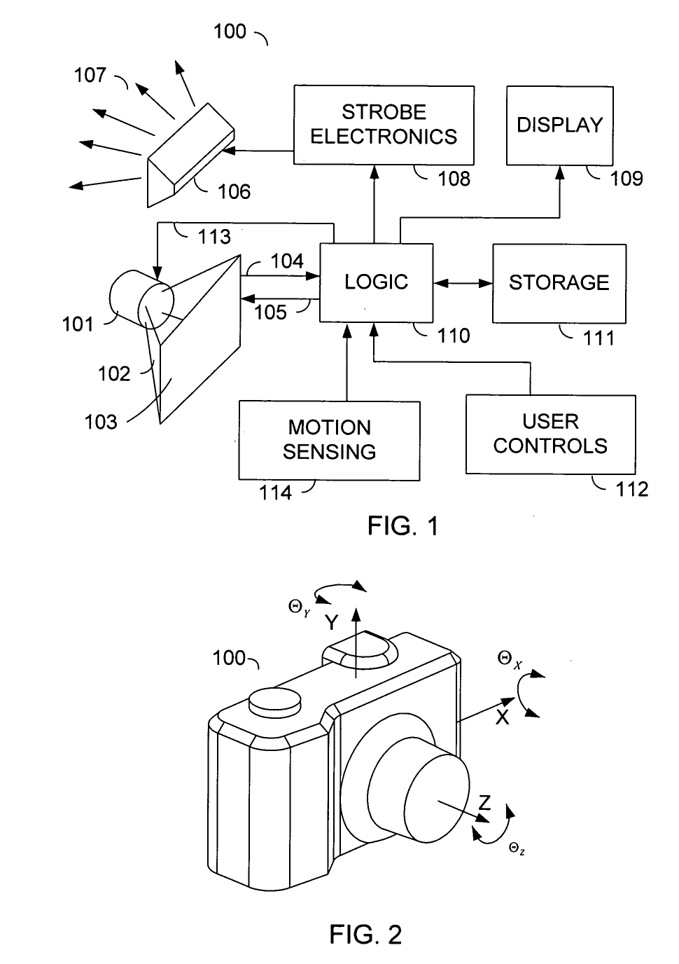

FIG. 1 shows a simplified block diagram of a digital camera 100 in accordance with an example embodiment of the invention. A lens 101 gathers light emanating from a scene, and redirects the light 102 such that an image of the scene is projected onto an electronic array light sensor 103. Electronic array light sensor 103 may be an array of charge coupled devices, commonly called a “CCD array”, a “CCD sensor”, or simply a “CCD”. Alternatively, electronic array light sensor 103 may be an array of active pixels constructed using complementary metal oxide semiconductor technology. Such a sensor may be called an “active pixel array sensor”, a “CMOS sensor”, or another similar name. Other sensor technologies are possible. The light-sensitive elements on electronic array light sensor 103 are generally arranged in an ordered rectangular array, so that each element, or “pixel”, corresponds to a scene location.

Image data signals 104 are passed to logic 110. Logic 110 interprets the image data signals 104, converting them to a numerical representation, called a “digital image”, a “digital photograph”, or simply an “image” or “photograph”. A digital image is an ordered array of numerical values that represent the brightness or color or both of corresponding locations in a scene or picture. Logic 110 may perform other functions as well, such as analyzing digital images taken by the camera for proper exposure, adjusting camera settings, performing digital manipulations on digital images, managing the storage, retrieval, and display of digital images, accepting inputs from a user of the camera, and other functions. Logic 110 also controls electronic array light sensor 103 through control signals 105. Logic 110 may comprise a microprocessor, a digital signal processor, dedicated logic, or a combination of these.

Storage 111 comprises memory for storing digital images taken by the camera, as well as camera setting information, program instructions for logic 110, and other items. User controls 112 enable a user of the camera to configure and operate the camera, and may comprise buttons, dials, switches, or other control devices. A display 109 may be provided for displaying digital images taken by the camera, as well as for use in conjunction with user controls 112 in the camera's user interface. A flash or strobe light 106 may provide supplemental light 107 to the scene, under control of strobe electronics 108, which are in turn controlled by logic 110. Logic 110 may also provide control signals 113 to control lens 101. For example, logic 110 may adjust the focus of the lens 101, and, if lens 101 is a zoom lens, may control the zoom position of lens 101.

Motion sensing element 114 senses motion of camera 100, and supplies information about the motion to logic 110.

FIG. 2 shows a perspective view of digital camera 100, and illustrates a coordinate system convenient for describing motions of camera 100. Rotations about the X and Y axes, indicated by rotation directions Θ_{X} and Θ_{Y} (often called pitch and yaw respectively), are the primary causes of image blur due to camera shake. Rotation about the Z axis and translations in any of the axis directions are typically small, and their effects are attenuated by the operation of the camera lens because photographs are typically taken at large inverse magnifications. However, these motion effects may be significant when a photograph is taken with an especially long exposure time, and may also be compensated.

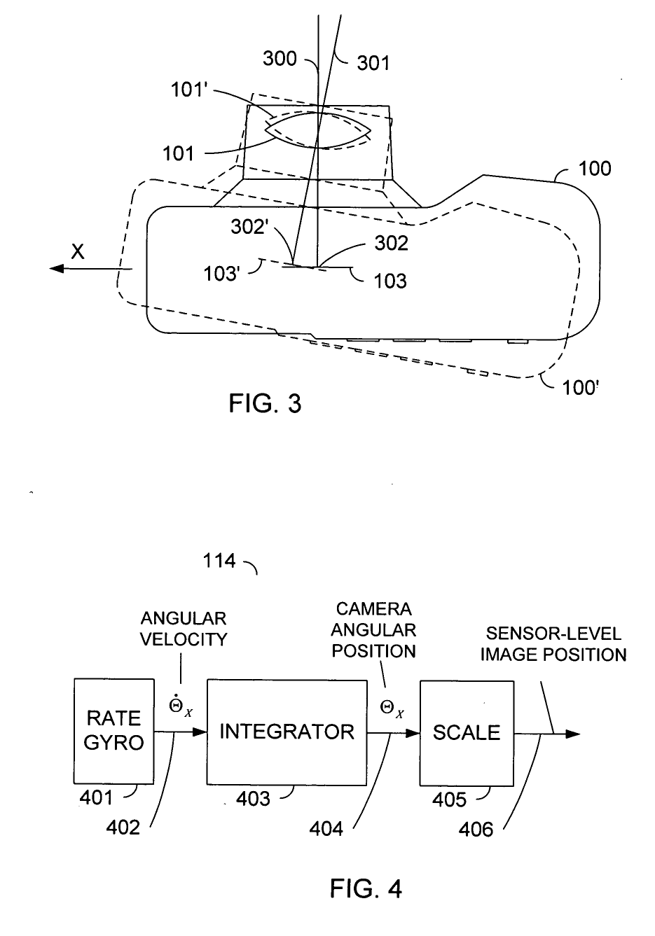

FIG. 3 shows a schematic top view of camera 100, and illustrates how camera rotation can cause image blur. In FIG. 3, camera 100 is shown in an initial position depicted by solid lines, and in a position, depicted by broken lines, in which camera 100 has been rotated about the Y axis. The reference numbers for the camera and other parts in the rotated position are shown as “primed” values, to indicate that the referenced items are the same items, shifted in position. In FIG. 3, a light ray 300 emanating from a particular scene location, passes through lens 101 and impinges on sensor 103 at a particular location 302. If the camera is rotated, the light ray is not affected in its travel from the scene location to the camera. However, sensor 103 moves to a new position, indicated by sensor 103′. The light ray, emanating from the same scene location, now impinges on sensor 103′ at a different sensor location than where it impinged on sensor 103, because position 302 has moved to position 302′. (This example is simplified somewhat. The travel of ray 300 within the camera may be affected by the rotation, but the effect is negligible for the purposes of this illustration.) If the rotation occurs during the taking of a photograph, then each of the sensor locations where the light ray impinged during the exposure will have collected light from the same scene location. A photograph taken during the rotation will thus be blurred because a particular sensor pixel collects light from many scene locations.

The amount of light collected from a particular scene location by a particular pixel is generally in proportion to the time duration for which rays from that scene location impinged on the pixel. This is generally inversely proportional to the speed of camera rotation during the impingement (and, of course, limited by the exposure time for the photograph).

FIG. 4 shows portion of motion sensing element 114 in greater detail, in accordance with an example embodiment of the invention. FIG. 4 shows only components for sensing motion about the X axis. Motion sensing element 114 preferably comprises a duplicate set of components for measuring motion about the Y axis. In the example of FIG. 4, camera rotation is sensed by a rate gyroscope 401. Rate gyroscope 402 produces a signal 402 proportional to the rate of camera rotation about the X axis. Integrator 403 integrates rate signal 402 to produce a signal 404 that indicates the camera angular position Θ_{X}. Signal 404 is scaled 405 to account for the focal length of lens 101, the geometry of sensor 103, and other characteristics of camera 100. The resulting image position signal 406 indicates the relative position of the scene image on sensor 103. One of skill in the art will recognize that other devices may be used to characterize camera motion. For example, a rotational accelerometer may measure acceleration about an axis, and a signal representing the acceleration may be integrated to obtain a signal similar to angular velocity signal 402. Other devices and methods for measuring camera motion may also be envisioned.

Integrator 403 may be an analog circuit, or the function of integrator 403 may be performed digitally. Similarly, scaling block 405 may be an analog amplifier, but preferably its function is performed digitally, so that changes in lens focal length may be easily accommodated. Some of the functions of motion sensing element 114 may be performed by logic 110. For example, integrator 403 and scaling block 405 may be performed by a microprocessor or other circuitry comprised in logic 110.

In accordance with an example embodiment of the invention, logic 110 monitors the camera motion by monitoring position signal 406, and uses the information to control camera 100 so that extreme motion blur is avoided, and also to perform image processing to substantially compensate for remaining motion blur that does occur in photographs taken by camera 100.

In a preferred embodiment, camera 100 avoids extreme motion blur by controlling, in response to the measured motion of camera 100, a starting time, and ending time, or both for a photographic exposure. For the purposes of this disclosure, the starting and ending times for a photographic exposure are called exposure boundaries. Techniques for selecting exposure boundaries for the purpose of avoiding extreme motion blur are known in the art.

Pending U.S. patent application Ser. No. 10/339,132, entitled “Apparatus and method for reducing image blur in a digital camera” and having a common inventor and a common assignee with the present application, describes a digital camera that delays the capture of a digital image after image capture has been requested until the motion of the digital camera satisfies a motion criterion. That application is hereby incorporated in its entirety as if it were reproduced here. In one example embodiment, the camera of application Ser. No. 10/339,132 delays capture of a digital image until the output of a motion tracking subsystem reaches an approximate local minimum, indicating that the camera is relatively still. Such a camera avoids extreme motion blur by selecting, in response to measured camera motion, an exposure boundary that is the starting time of an exposure interval.

Pending U.S. patent application Ser. No. 10/842,222, entitled “Image-exposure system and methods” and also having a common inventor and a common assignee with the present application, describes detecting motion and determining when to terminate an image exposure based on the detected motion of a camera. That application is hereby incorporated in its entirety as if it were reproduced here. In one example embodiment described in application Ser. No. 10/842,222, an image-exposure system comprises logic configured to terminate an exposure when the motion exceeds a threshold amount. Such a method avoids extreme motion blur by selecting, in response to measured camera motion, an exposure boundary that is the ending time of and exposure interval.

Other methods and devices may be envisioned that select, based on measured camera motion, a starting time, an ending time, or both for a photographic exposure. In example camera 100, logic 110 monitors the camera motion, as detected by motion sensing element 114, and selects one or more exposure boundaries for a photograph.

Devices and methods also exist in the art for performing image processing to substantially compensate for motion blur. Pending U.S. patent application Ser. No. 11/148,985, entitled “A method and system for deblurring an image based on motion tracking” and having a common assignee with the present application, describes deblurring an image based on motion tracking. That application is hereby incorporated in its entirety as if it were reproduced here. In one example embodiment described in application Ser. No. 11/148,985, motion of an imaging device is sensed during a photographic exposure, a blur kernel is generated based on the motion, and the resulting photograph is deblurred based on the blur kernel.

Preferably, image processing performed to compensate for motion blur, in accordance with an example embodiment of the present invention, is performed using frequency-domain methods. Such methods are known in the art. See for example The Image Processing Handbook, 2^{nd} ed. by John C. Russ, CRC Press, 1995. An example of frequency domain processing is given below.

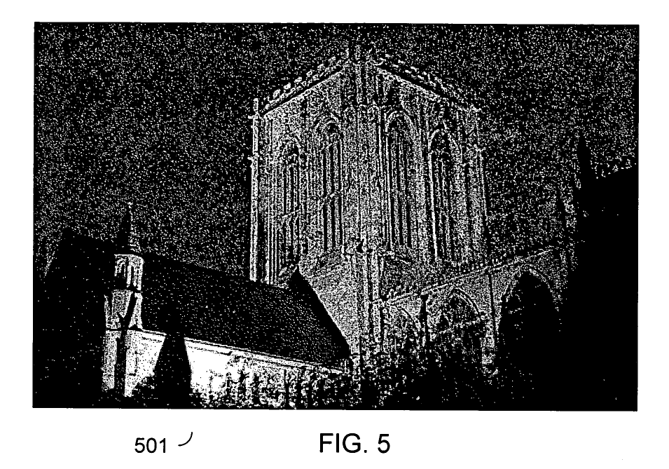

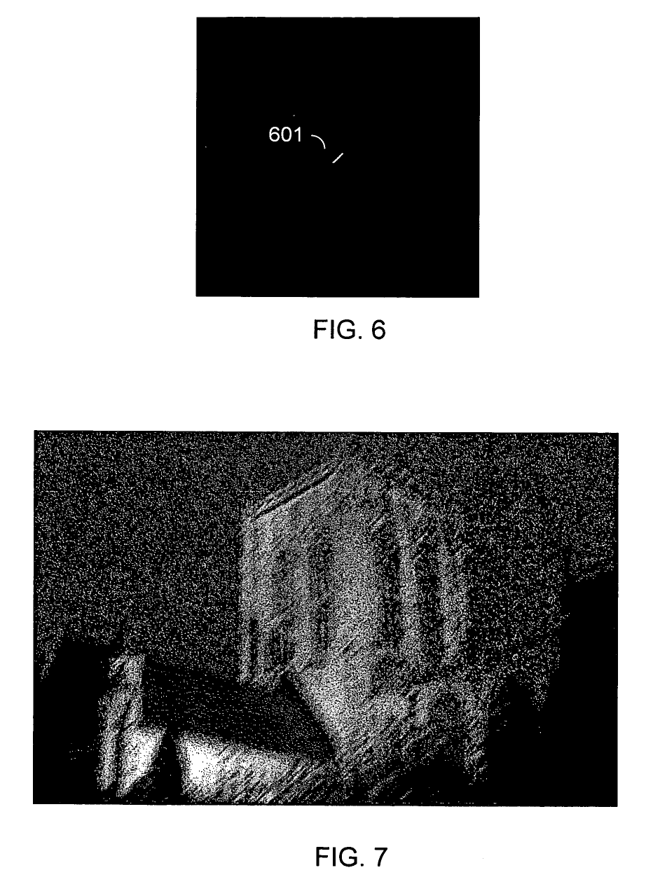

FIG. 5 illustrates a scene, a portion of which is to be photographed. While FIG. 5 is shown in black and white for simplicity of printing and illustration, one of skill in the art will recognize that the techniques to be discussed may be applied to color images as well. Suppose that during the exposure of a photograph of a portion of scene 501 using camera 100, camera 100 moves such that its optical axis moves upward and to the right across the scene. FIG. 6 illustrates a “blur vector” 601 describing this motion, in which the camera optical axis traverses the scene at a 45-degree angle, at a uniform velocity, for a distance of nine pixels in image space. Of course, more complicated paths are possible than the one shown in this simple example. In a case where the speed of the motion varies during the exposure, sections of the blur vector depicting slower portions of the motion will be brighter than portions depicting faster portions. Blur vector 601 is centered in an image 256 pixels on a side. While image sizes with dimensions that are integer powers of two facilitate frequency domain processing, this is not a requirement.

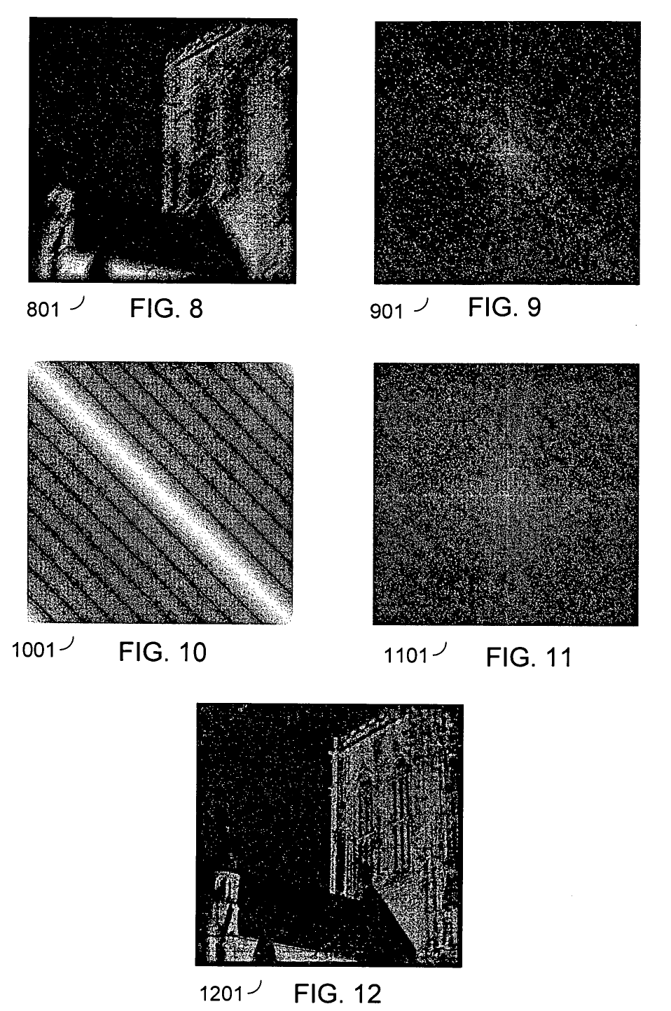

FIG. 7 depicts scene 501 as it would appear blurred by the camera motion represented by blur vector 601. FIG. 8 depicts a 256-pixel by 256-pixel photograph 801 taken of a portion of scene 501, also blurred. The perimeter edges of photograph 801 have been softened somewhat to reduce noise induced by later steps. Motion blur may be substantially removed from an image by computing two dimensional discrete Fourier transforms of both the blur vector and the original image, dividing the transform of the image point-by-point by the transform of the blur vector, and then computing the two-dimensional inverse discrete Fourier transform of the result.

FIG. 9 shows the two-dimensional Fourier transform 901 of photograph 801, computed using a Fast Fourier Transform (FFT) implementation of the discrete Fourier transform. (The Fourier transforms are computed using complex arithmetic. The Fourier transform plots in the drawings show only the magnitude of each entry, scaled in brightness for better illustration.) FIG. 10 shows the two-dimensional Fourier transform 1001 of image of FIG. 6, including blur vector 601.

FIG. 11 shows the Fourier transform 1101 that results from dividing Fourier transform 901 by Fourier transform 1001. Because a point-by-point division is performed, dividing the elements of Fourier transform 901 by the elements of Fourier transform 1001, entries in Fourier transform 1001 that are near zero in magnitude can cause overflow or noise in the resulting image. It may be useful to set small elements of Fourier transform 1001 to a minimum value greater than zero, or to compute the element-by-element reciprocal of Fourier transform 1001 and set large elements to a maximum value. In this example, Fourier transform 1001 was inverted and each entry clipped to a maximum magnitude of 15 units, and then the Fourier transforms were multiplied.

FIG. 12 shows recovered photograph 1201, which is the result of computing the two-dimensional inverse of Fourier transform 1101. As compared with photograph 801, recovered photograph 1201 shows considerably more detail. The frequency-domain deblurring has substantially removed the motion blur.

The combination, in camera 100, of avoiding extreme motion blur by selecting one or more exposure boundaries for a photograph coupled with image processing to compensate for residual blur in the resulting photograph, provides a synergistic improvement in image quality. Each capability enhances the performance of the other.

While image processing performed to remove motion blur can improve an image considerably, it can introduce noise artifacts into the image, some of which are visible in recovered photograph 1201. These artifacts tend to be worse when the motion blur vector has a complex trajectory or extends over a relatively large number of pixels. That is, the larger and more complex the camera motion, the less reliable image processing is for recovering an unblurred image. Furthermore, when the exposure time for a photograph is long enough that large or complex camera motions can occur during the exposure, other uncompensated camera motion is also more likely to occur. For example, camera rotation about the Z axis, or camera translations may occur, which are not detected by motion sensing element 114. These motions may cause the image processing to fail to remove image blur. Because camera 100 avoids extreme motion blur by selecting the starting time, ending time, or both of a photographic exposure, image processing performed to remove the residual blur from the resulting photograph is likely to result in a pleasing image. The blur vector is kept to a manageable size, and the exposure time may be kept short enough that the other, uncompensated motions remain insignificant.

Similarly, the ability to perform image processing to compensate for image blur allows more flexible use of blur minimization by selection of exposure boundaries based on camera motion. Without the capability to perform the image processing, camera 100 would constrain exposure times based on camera motion so that the resulting photographs were acceptably sharp. With the capability of performing the image processing, camera 100 can extend exposure times, relying on the image processing to correct the motion blur that occurs. These extended exposure times are very desirable because they allow the photographer increased flexibility, and can enable convenient handheld camera operation in situations where it would otherwise be infeasible.

Furthermore, these performance improvements are accomplished without the need for actuating an optical element in the camera. Much of the required control and processing occurs in logic 110, which would likely be present in a camera without an embodiment of the invention. If the image processing to compensate for the residual motion blur is performed by using a blur kernel, the relatively small blur vector allowed by the extreme blur avoidance may also reduce the time required to perform the image processing, as compared with a camera that relies on image processing alone to compensate for motion blur.

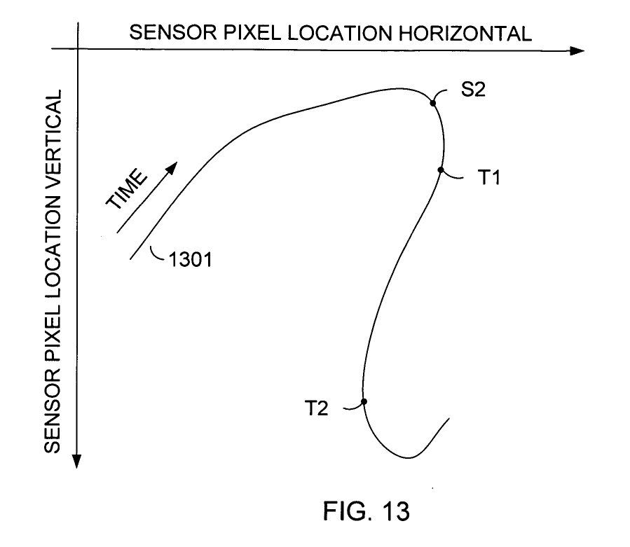

In another example embodiment of the invention, logic 110 is configured to choose exposure boundaries encompassing camera motion that is especially amenable to compensation by digital image processing. For example, logic 110 may favor linear motion in its selection of exposure boundaries for a photograph, choosing exposure boundaries between which the camera motion is substantially linear. For the purposes of this disclosure, linear motion is camera motion that causes the camera's optical axis to trace a straight line on an imaginary distant surface. Linear motion also results in a blur vector that is a straight line. Note that during linear motion, the camera may actually be rotating about one or more axes. FIG. 13 shows an example motion trajectory 1301. Motion trajectory 1301 represents a trace on sensor 103 of the locations upon which light rays from a particular scene location impinge as a function of time. The trajectory is represented in “image space” and distances along the trajectory are measured in pixels. In this example, the photographer presses a shutter release of camera 100 to its “S2” position at point S2, indicating that a photograph is to be taken. Based on the signals provided by motion sensing element 114, logic 110 recognizes that trajectory 1301 has recently undergone significant curvature. Because curvature in the camera motion adds complexity to the blur vector, and therefore increases the difficulty of compensating for motion blur using image processing, logic 110 waits until time T1 to begin the exposure of the photograph. At time T1, logic 110 recognizes that trajectory 1301 has recently exhibited little curvature. The exposure continues until time T2, when logic 110 recognizes that trajectory 1301 has again begun exhibiting significant curvature, and terminates the exposure. The segment of trace 1301 between T1 and T2 represents the blur vector for the photograph taken with an exposure time starting at T1 and ending at T2.

If sufficient exposure has occurred before time T2, logic 110 may terminate the exposure before time T2. Likewise, if the delay between S2 and T1 is too long for crisp camera operation, that is, if after S2 logic 110 must wait an excessively long time before finding a trajectory portion with little curvature, logic 110 may start the exposure recognizing that curvature is occurring in the interest of being quickly responsive to the photographer's command.

Criteria for determining times T1 and T2 will depend on the camera geometry, lens focal length, the processing capability of logic 110, and other factors. For example, logic 110 may select T1 to be a time when trajectory 1301 has not deviated from a straight line by more than a first predetermined number of pixels in a second predetermined number of previous pixels most recently traversed. For example, logic 110 may select T1 to be a time when trajectory 1301 has not deviated from a straight line by more than three pixels in image space in the previous 10 pixels traversed. Similarly, logic 110 may select T2 to be a time when trajectory 1301 has again deviated from a straight line by a first predetermined number of pixels in a second predetermined number of pixels most recently traversed. For example, logic 110 may select T2 to be a time when trajectory 1301 has again deviated from a straight line by more than three pixels in image space in the previous 10 pixels traversed. The first and second predetermined numbers of pixels used for selecting T1 need not be the same as the first and second predetermined numbers used for selecting T2.

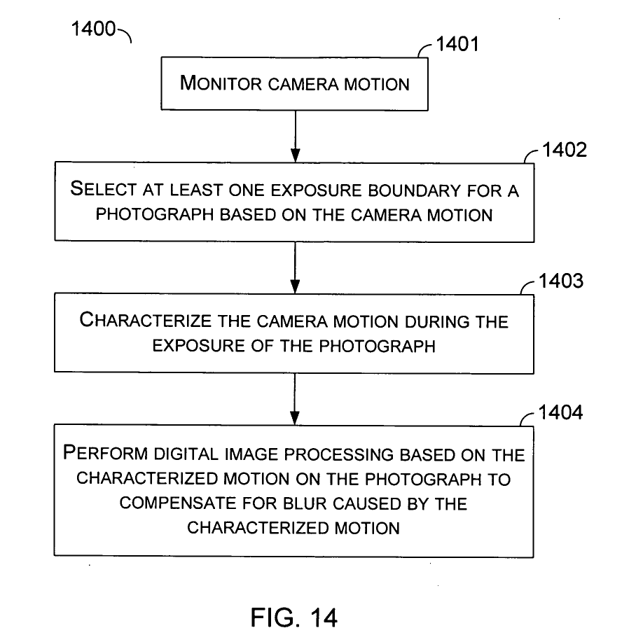

FIG. 14 shows a flowchart 1400 of a method in accordance with an example embodiment of the invention. In step 1401, camera motion is monitored. In step 1402, at least one exposure boundary is selected for a photograph based on the camera motion. At step 1403, motion of the camera is characterized during the exposure of the photograph. At step 1404, digital image processing is performed, based on the characterized motion, on the resulting photograph to compensate for blur caused by the characterized motion.

1. A method, comprising:
monitoring motion of a camera;
selecting, based on the monitored motion, at least one exposure boundary for a photograph;
characterizing motion of the camera during the exposure of the photograph; and
performing digital image processing based on the characterized motion on the photograph to compensate for blur caused by the characterized motion.

2. The method of claim 1, wherein selecting at least one exposure boundary further comprises selecting a starting time for the exposure.

3. The method of claim 2, further comprising delaying the starting time for the exposure until the monitored motion satisfies a motion criterion.

4. The method of claim 1, wherein selecting at least one exposure boundary further comprises selecting an ending time for the exposure.

5. The method of claim 4, further comprising terminating the exposure when the camera motion reaches a threshold amount.

6. The method of claim 1, wherein selecting at least one exposure boundary further comprises selecting both a starting time and an ending time for the exposure.

7. The method of claim 1, wherein the exposure boundaries are selected to encompass camera motion that is amenable to compensation by digital image processing.

8. The method of claim 1, wherein an exposure starting time is selected to be a time when the camera has recently exhibited substantially linear motion.

9. The method of claim 8, wherein substantially linear motion is found when a trajectory of the camera motion has not deviated by more than a first predetermined number of pixels from a straight line in image space in a second predetermined number of pixels most recently traversed.

10. The method of claim 9, wherein substantially linear motion is found when the trajectory of the camera motion has not deviated by more than three pixels from a straight line in image space in the previous 10 pixels traversed.

11. The method of claim 1, wherein an exposure ending time is selected to be a time when the camera has begun exhibiting significantly nonlinear motion.

12. The method of claim 11, wherein significantly nonlinear motion is found when a trajectory of the camera motion has deviated by more than a first predetermined number of pixels from a straight line in image space in a second predetermined number of pixels most recently traversed.

13. The method of claim 12, wherein significantly nonlinear motion is found when the trajectory of the camera motion has deviated by more than three pixels from a straight line in image space in the previous 10 pixels traversed.

14. The method of claim 1, wherein performing digital image processing further comprises:
generating a blur kernel based on the characterized motion; and
deblurring the resulting photograph based on the blur kernel.

15. The method of claim 1, wherein the digital image processing is performed in the frequency domain.

16. The method of claim 1, wherein exposure boundaries are selected such that extreme motion blur in the photograph is avoided.

17. The method of claim 1, wherein the camera motion comprises at least one of pitch and yaw.

18. A camera, comprising:
a motion sensing element producing a signal indicative of motion of the camera; and
logic receiving the signal, the logic configured to
select, based on the camera motion, at least one exposure boundary for a photographic exposure,
characterize the camera motion during the photographic exposure, and
perform digital image processing on a resulting photograph based on the characterized motion, the image processing compensating for motion blur in the photograph.

19. The camera of claim 18, wherein the logic is configured to select, based on the monitored motion, a starting time for the photographic exposure.

20. The camera of claim 18, wherein the logic is configured to select, based on the monitored motion, an ending time for the photographic exposure.

21. The camera of claim 18, wherein the logic is configured to select, based on the monitored motion, both a starting time and an ending time for the photographic exposure.

22. The camera of claim 18, wherein exposure boundaries are selected such that extreme motion blur in the photograph is avoided.

23. The camera of claim 18, wherein exposure boundaries are selected to encompass camera motion that is amenable to compensation by digital image processing.

24. The camera of claim 18, wherein the motion sensing element further comprises at least one rate gyroscope.

25. The camera of claim 18, wherein the motion sensing element further comprises at least one accelerometer.

26. The camera of claim 18, wherein the logic is further configured to generate a blur kernel based on the characterized motion and to deblur the photograph using the blur kernel.

27. The camera of claim 18, wherein the logic is further configured to perform the image processing using frequency domain methods.
